(19) United States
(12) Patent Application Publication
(10) Pub. No.: US 2019/0264012 A1
(43) Pub. Date: Aug. 29, 2019

(54) RUBBER COMPOSITION FOR TIRE AND PNEUMATIC TIRE USING SAME

(71) Applicant: Toyo Tire Corporation, Itami-shi, Hyogo (JP)

(72) Inventor: Yasuhiro Hishikawa, Itami-shi (JP)

(73) Assignee: Toyo Tire Corporation, Itami-shi, Hyogo (JP)

(21) Appl. No.: 16/346,557

(22) PCT Filed: Dec. 7, 2017
(86) PCT No.: PCT/JP2017/043965

§ 371 Date: May 1, 2019

(30) Foreign Application Priority Data
Dec. 15, 2016 (JP) 2016-243409

(51) Int. Cl. C08L 15/00; B60C 1/00

(52) U.S. Cl. CPC C08L 15/00; C08L 2312/00; B60C 1/0025; B60C 1/0016

(57) ABSTRACT

Provided a rubber composition for a tire that can improve processability while maintaining reinforcing property that is a property of a hydrogenated copolymer, and a pneumatic tire using the same. A rubber composition for a tire comprising 100 parts by mass of a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and 3 to 30 parts by mass of crosslinked rubber particles.

### TECHNICAL FIELD

The present invention relates to a rubber composition for a tire and a pneumatic tire using the same.

### BACKGROUND ART

Rubber constituting a pneumatic tire is required to have excellent rupture strength (reinforcing property). As a method for improving rupture strength of a rubber, Patent Documents 1 and 2 disclose using a hydrogenated copolymer having a hydrogenation ratio of a conjugated diene moiety of 75 mol % or more, obtained by copolymerizing aromatic vinyl and a conjugated diene compound.

### PRIOR ART DOCUMENTS

### Patent Document

Patent Document 1: JP-A-2016-56349
Patent Document 2: JP-A-2016-56350
Patent Document 3: JP-A-2003-253051

### SUMMARY OF THE INVENTION

### Problems that the Invention is to Solve

However, a rubber composition using a hydrogenated copolymer having high hydrogenation ratio had the problem that smoothness of the surface and ends when the rubber composition is formed into a sheet shape (hereinafter referred to as processability) is deteriorated.

In view of the above, the present invention has an object to provide a rubber composition for a tire that can improve processability while maintaining reinforcing property that is a property of a hydrogenated copolymer, and a pneumatic tire using the same.

Patent Document 3 has an object to improve workability in a factory of a rubber composition using a hydrogenated copolymer, but the improvement of surface state and the like when formed into a sheet shape is not described therein.

### Means for Solving the Problems

To solve the above-described problems, the rubber composition for a tire according to the present invention comprises 100 parts by mass of a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and 3 to 30 parts by mass of crosslinked rubber particles.

The pneumatic tire according to the present invention can be manufactured using the rubber composition for a tire.

### Effects of the Invention

According to the rubber composition for a tire of the present invention, processability can be improved while maintaining reinforcing property that is a property of a hydrogenated copolymer.

### MODE FOR CARRYING OUT THE INVENTION

The items relating to the embodiment of the present invention are described in detail below.

A rubber component used in the rubber composition according to this embodiment is a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more. In the present description, the weight average molecular weight measured by gel permeation chromatography (GPC) is a value calculated in terms of polystyrene based on commercially available standard polystyrene, using a differential refractive index detector (RI) as a detector and using tetrahydrofuran (THF) as a solvent under the conditions that a measurement temperature is 40° C., a flow rate is 1.0 mL/min, a concentration is 1.0 g/L and an injection quantity is 40 μL. The hydrogenation ratio is a value calculated from a spectrum decrease rate of an unsaturated bond moiety of a spectrum obtained by measuring H¹-NMR.

The aromatic vinyl constituting the aromatic vinyl-conjugated diene copolymer is not particularly limited, but examples thereof include styrene, α-methylstyrene, 1-vinylnaphthalene, 3-vinyltoluene, ethylvinylbenzene, divinylbenzene, 4-cyclohexylstyrene and 2,4,6-trimethylstyrene. Those may be used alone or as a combination of two or more kinds.

The conjugated diene constituting the aromatic vinyl-conjugated diene copolymer is not particularly limited, but examples thereof include 1,3-butadiene, isoprene, 1,3-pentadiene, 2,3-dimethylbutadiene, 2-pheny-1,3-butadiene and 1,3-hexadiene. Those may be used alone or as a combination of two or more kinds.

The aromatic vinyl-conjugated diene copolymer is not particularly limited, but a copolymer of styrene and 1,3-butadiene (styrene-butadiene copolymer) is preferred. Therefore, the hydrogenated copolymer is preferably a hydrogenated styrene-butadiene copolymer. The hydrogenated copolymer may be a random copolymer, may be a block copolymer and may be an alternating copolymer. The aromatic vinyl-conjugated diene copolymer may be modified with at least one functional group selected from the group consisting of amino group, hydroxyl group, epoxy group, alkoxy group, alkylsilyl group, alkoxysilyl group and carboxyl group at a molecular end or in a molecular chain.

The hydrogenated copolymer can be synthesized by, for example, synthesizing an aromatic vinyl-conjugated diene copolymer and conducting a hydrogenation treatment. A method for synthesizing the aromatic vinyl-conjugated diene copolymer is not particularly limited, but the examples thereof include a solution polymerization method, a gas phase polymerization method and a bulk polymerization method, and a solution polymerization method is preferred. The polymerization form may be any of a batch type and a continuous type. The aromatic vinyl-conjugated diene copolymer can use the commercially available copolymers.

The hydrogenation method is not particularly limited, and the aromatic vinyl-conjugated diene copolymer is hydrogenated by the conventional method under the conventional conditions. The hydrogenation is generally conducted at 20 to 150° C. under a hydrogen pressure of 0.1 to 10 MPa in the presence of a hydrogenation catalyst. The hydrogenation ratio can be optionally adjusted by changing the amount of a hydrogenation catalyst, a hydrogen pressure when hydrogenating, a reaction time and the like. The hydrogenation catalyst can generally use a compound containing any of metals of Groups 4 to 11 of the periodic table. For example, a compound containing Ti, V, Co, Ni, Zr, Ru, Rh, Pd, Hf, Re or Pt atom can be used as the hydrogenation catalyst. Examples of more specific hydrogenation catalysts include a metallocene compound such as Ti, Zr, Hf, Co, Ni, Pd, Pt, Ru, Rh or Re; a supported type heterogeneous catalyst comprising a carrier such as carbon, silica, alumina or diatomaceous earth and a metal such as Pd, Ni, Pt, Rh or Ru supported thereon; a homogeneous Ziegler catalyst comprising a combination of an organic salt or acetylacetone salt of a metal element such as Ni or Co and a reducing agent such as organic aluminum; an organic metal compound or complex of Ru or Rh; and fullerene or carbon nanotube having hydrogen occluded therein.

The hydrogenation ratio of the hydrogenated copolymer (proportion of hydrogenated moiety in conjugated moiety diene of aromatic vinyl-conjugated diene copolymer) is 80 mol % or more and preferably 90 mol % or more.

The weight average molecular weight of the hydrogenated copolymer is not particularly limited so long as it is 300,000 or more. The weight average molecular weight is preferably 300,000 to 2,000,000, more preferably 300,000 to 1,000,000 and still more preferably 300,000 to 600,000.

The rubber component may contain a diene rubber other than the hydrogenated copolymer, and examples of the diene rubber include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The content ratio of the hydrogenated copolymer in the rubber component is not particularly limited, but, is preferably 80 to 100 mass % and more preferably 90 to 100 mass %.

The rubber composition according to this embodiment contains crosslinked rubber particles. The crosslinked rubber particles are particulate rubber comprising a crosslinked body having a diene rubber structure and are distinguished from the rubber component.

Examples of the diene rubber constituting the crosslinked rubber particles include natural rubber, isoprene rubber, styrene-butadiene rubber, butadiene rubber, styrene-isoprene rubber, butadiene-isoprene rubber, styrene-isoprene-butadiene copolymer rubber and nitrile rubber. Those may be used alone and may be used as a combination of two or more kinds. The diene rubber preferably comprises butadiene rubber, styrene butadiene rubber or nitrile rubber as a main component.

The crosslinked rubber particles may be modified diene rubber particles having a functional group. Examples of the functional group include functional groups containing a hetero atom, such as a hydroxyl group, a carboxyl group, an amino group, a thiol group and a sulfo group. The functional group may be synthesized using a monomer having a functional group introduced therein when polymerizing the diene rubber, and an end-modified rubber obtained by introducing a functional group to an active end after polymerization can be used too. The functional group also can be incorporated in the particle surface by preparing diene rubber particles by crosslinking and then reacting a compound having a functional group with C═C double bond on the particle surface.

The content of the crosslinked rubber particles is 3 to 30 parts by mass, preferably 5 to 30 parts by mass and more preferably 10 to 30 parts by mass, per 100 parts by mass of the hydrogenated copolymer.

The average particle diameter of the crosslinked rubber particles is not particularly limited, but is preferably 30 nm to 300 μm and more preferably 50 nm to 200 μm. The average particle diameter in the present description is an average particle diameter (particle diameter of 50% integrated value) obtained from a laser diffraction scattering method.

The shape of the crosslinked rubber particles is not particular limited, and may be any of a spherical shape, a flat shape, a dendritic shape and an amorphous shape.

A method for producing the crosslinked rubber particles is not limited, and, for example, the crosslinked rubber particles can be produced by producing a rubber dispersion and crosslinking the rubber dispersion while maintaining the dispersion state. Examples of the rubber dispersion include a rubber latex produced by suspension polymerization and a rubber dispersion obtained by emulsifying a solution-polymerized rubber in water. Examples of the crosslinking agent include organic peroxide and a sulfur type crosslinking agent. The crosslinking of the rubber particles can be conducted by copolymerization with a polyfunctional group having crosslinking action during emulsion polymerization of a rubber. Specifically, the methods disclosed in JP-A-H-6-57038, JP-A-H-10-204225, JP-A-2004-504465, JP-A-2004-506058, JP-A-2004-530760 and the like can be used. The crosslinked rubber particles may be particles obtained by grinding a bulk-shaped vulcanized rubber.

In the rubber composition according to this embodiment, carbon black and/or silica can be used as a reinforcing filler. In other words, the reinforcing filler may be carbon black alone, may be silica alone and may be a combination of carbon black and silica. A combination of carbon black and silica is preferably used. The content of the reinforcing filler is not particularly limited, and is, for example, preferably 10 to 150 parts by mass, more preferably 20 to 100 parts by mass and still more preferably 30 to 80 parts by mass, per 100 parts by mass of the total of the rubber component and the crosslinked rubber particles.

The carbon black is not particularly limited and conventional various kinds can be used. The content of the carbon black is preferably 1 to 70 parts by mass and more preferably 1 to 60 parts by mass, per 100 parts by mass of the total of the rubber component and the crosslinked rubber particles.

The silica is not particularly limited, but wet silica such as wet precipitated silica or wet gelled silica is preferably used. When the silica is contained, its content is preferably 10 to 120 parts by mass and more preferably 15 to 100 parts by mass, per 100 parts by mass of the total of the rubber component and the crosslinked rubber particles from the standpoints of balance of tan 8 of rubber, reinforcing property and the like.

When the silica is contained, a silane coupling agent such as sulfide silane or mercaptosilane may be further contained. When the silane coupling agent is contained, its content is preferably 2 to 20 mass % based on the silica content.

In addition to the above components, compounding ingredients used in general rubber industries, such as a process oil, zinc flower, stearic acid, a softener, a plasticizer, a wax, an age resister, a vulcanizing agent and a vulcanization accelerator can be appropriately added in the general range to the rubber composition according to this embodiment.

Examples of the vulcanizing agent include sulfur components such as powdered sulfur, precipitated sulfur, colloidal sulfur, insoluble sulfur and highly dispersible sulfur. Although not particularly limited, the content of the vulcanizing agent is preferably 0.1 to 10 parts by mass and more preferably 0.5 to 5 parts by mass, per 100 parts by mass of the total of the rubber component and the crosslinked rubber particles. The content of the vulcanization accelerator is preferably 0.1 to 7 parts by mass and more preferably 0.5 to 5 parts by mass, per 100 parts by mass of the total of the rubber component and the crosslinked rubber particles.

The rubber composition according to this embodiment can be produced by kneading the necessary components according to the conventional method using a mixing machine generally used, such as Banbury mixer, a kneader or rolls. Specifically, additives excluding a vulcanizing agent and a vulcanization accelerator are added to the rubber component together with the crosslinked rubber particles, followed by mixing, in a first mixing step, and a vulcanizing agent and a vulcanization accelerator are added to the mixture obtained, followed by mixing, in a final mixing step. Thus, a rubber composition can be prepared.

The rubber composition thus obtained can be used for a tire and can be applied to each site of a tire, such as a tread part or a sidewall part of pneumatic tires having various uses and sizes, such as tires for passenger cars or large-seize tires for trucks or buses. The rubber composition is molded into a predetermined shape by, for example, extrusion processing according to the conventional method, combined with other parts and then vulcanized at, for example, 140 to 180° C. Thus, a pneumatic tire can be manufactured.

The kind of the pneumatic tire according to this embodiment is not particularly limited, and examples of the pneumatic tire include various tires such as tires for passenger cars and heavy load tires for trucks, buses and the like.

### EXAMPLES

Examples of the present invention are described below, but the present invention is not construed as being limited to those examples.

### Synthesis Example 1 of Hydrogenated Copolymer

2.5 L of cyclohexane, 50 g of tetrahydrofuran, 0.12 g of n-butyl lithium, 100 g of styrene and 400 g of 1,3-butadiene were put in a nitrogen-substituted heat-resistant reactor, and polymerization was conducted at a reaction temperature of 50° C. After completion of the polymerization, 1.7 g of N,N-bis(trimethylsilyl)aminopropylmethyl diethoxysilane was added, a reaction was conducted for 1 hour and hydrogen gas was then supplied under a pressure of 0.4 MPa-gauge. The reaction was conducted at a reaction temperature of 90° C. under a hydrogen gas supply pressure of 0.7 MPa-gauge using a catalyst mainly comprising titanocene dichloride until reaching a target hydrogenation ratio. Solvent was removed to obtain hydrogenated copolymer 1.

The hydrogenated copolymer obtained had a weight average molecular weight by GPC of 350,000 in terms of polystyrene based on standard polystyrene. The measurement was conducted using “LC-10A” manufactured by Shimadzu Corporation as a measuring instrument using “PLgel-MIXED-C” manufactured by Polymer Laboratories as a column, using a differential refractive index detector (RI) as a detector and using THF as a solvent under the conditions that a measurement temperature is 40° C., a flow rate is 1.0 mL/min, a concentration is 1.0 g/L and an injection amount is 40 L. The amount of bonded styrene was 20 mass % and the hydrogenation ratio of the butadiene moiety was 90 mol %. The amount of the bonded styrene was obtained from a spectrum intensity ratio of proton based on styrene unit and proton based on butadiene unit (containing hydrogenated portion) using H¹-NMR.

### Synthesis Example 2 of Hydrogenated Copolymer

Hydrogenated copolymer 2 was obtained by the same method as Synthesis Example 1, except for changing the reaction time for hydrogenation and changing the target hydrogenation ratio. The hydrogenated copolymer 2 obtained had a weight average molecular weight of 350,000 in terms of polystyrene based on standard polystyrene. The amount of bonded styrene was 20 mass % and the hydrogenation ratio of the butadiene moiety was 80 mol %.

### Examples and Comparative Examples

Using a Banbury mixer, components excluding a vulcanization accelerator and sulfur were added according to the formulations (parts by mass) shown in Table 1 below, followed by mixing, in a first mixing step (non-processing kneading step) (discharge temperature: 160° C.). A vulcanization accelerator and sulfur were added to the mixture obtained, followed by mixing, in a final mixing step (processing kneading step) (discharge temperature: 90° C.). Thus, a rubber composition was prepared.

The details of each component in Table 1 are as follows.

Hydrogenated SBR 1: Hydrogenated copolymer 1 prepared according to Synthesis Example 1

Hydrogenated SBR 2: Hydrogenated copolymer 2 prepared according to Synthesis Example 2

BR: “BR01” manufactured by JSR Corporation

Silica: “Ultrasil VN3” manufactured by Evonik

Carbon black: “SEAST 3” manufactured by Tokai Carbon Co., Ltd.

Oil: “PROCESS NC140” manufactured by JX Nippon Oil & Sun Energy Corporation

Crosslinked rubber particles 1: “NANOPRENE M20” manufactured by Lanxess, polymer gel having hydroxyl group and having Tg of −20° C., comprising diene rubber as a base, average particle diameter: 60 nm

Crosslinked rubber particles 2: “NANOPRENE BM750H” manufactured by Lanxess, polymer gel having hydroxyl group and having Tg of −75° C., comprising BR as a base, average particle diameter: 60 nm

Crosslinked rubber particles 3: “PD140” manufactured by Lehigh Technologies, pulverized product of vulcanized rubber, average particle diameter: 100 μm

Zinc flower: “Zinc Flower #3” manufactured by Mitsui Mining & Smelting Co., Ltd.

Stearic acid: “LUNAC S-20” manufactured by Kao Corporation

Age resister: “NOCRAC 6C” manufactured by Ouchi Shinko Chemical Industrial Co., Ltd.

Wax: “OZOACE 0355” manufactured by Nippon Seiro Co., Ltd.

Silane coupling agent: “Si69” manufactured by Evonik

Sulfur: “Powdered Sulfur” manufactured by Tsurumi Chemical Industry Co., Ltd.

Vulcanization accelerator 1: “NOCCELER D” manufactured by Ouchi Shinko Chemical Industrial Co., Ltd.

Vulcanization accelerator 2: “SOXINOL CZ” manufactured by Sumitomo Chemical Co., Ltd.

Vulcanization accelerator 3: “ACCEL TBZT” manufactured by Kawaguchi Chemical Industry Co., Ltd.

Processability and reinforcing property of each composition obtained were evaluated. The evaluation methods are as follows.

Processability: The unvulcanized rubber discharged in the final mixing step was formed into a sheet shape by 8-inch rolls, and the state of the surface and both ends of the sheet was observed. The sheet having the state that the surface and both ends were smooth is indicated as “O”, and the sheet corresponding to at least one of the state that the surface was rugged and the state that both ends were jagged is indicated as “x”.

Reinforcing property: Using a test piece having a predetermined shape obtained by vulcanizing the rubber composition obtained at 160° C. for 30 minutes, a tensile test (Dumbbell-shaped 3) was conducted according to JIS K6251 and stress (S300) at 300% elongation was measured. The reinforcing property is indicated by an index as the value of Comparative Example 1 being 100. Larger value indicates large stress and shows excellent reinforcing property.

TABLE 1

| | Com. Ex. 1 | Com. Ex. 2 | Com. Ex. 3 | Ex. 1 | Ex. 2 | Ex. 3 | Ex. 4 | Ex. 5 |
|---|---|---|---|---|---|---|---|---|
| Hydrogenated SBR1 | 100 | 80 | 100 | 90 | 80 | 90 | 90 | — |
| Hydrogenated SBR2 | — | — | — | — | — | — | — | 90 |
| BR | — | 20 | — | — | — | — | — | — |
| Silica | 60 | 60 | 60 | 60 | 60 | 60 | 60 | 60 |
| Carbon black | 5 | 5 | 5 | 5 | 5 | 5 | 5 | 5 |
| Oil | 15 | 15 | 25 | 15 | 15 | 15 | 15 | 15 |
| Crosslinked rubber particles 1 | — | — | — | 10 | 20 | — | — | — |
| Crosslinked rubber particles 2 | — | — | — | — | — | 10 | — | 10 |
| Crosslinked rubber particles 3 | — | — | — | — | — | — | 10 | — |
| Zinc flower | 3 | 3 | 3 | 3 | 3 | 3 | 3 | 3 |
| Stearic acid | 2 | 2 | 2 | 2 | 2 | 2 | 2 | 2 |
| Age resister | 2 | 2 | 2 | 2 | 2 | 2 | 2 | 2 |
| Wax | 2 | 2 | 2 | 2 | 2 | 2 | 2 | 2 |
| Silane coupling agent | 5 | 5 | 5 | 5 | 5 | 5 | 5 | 5 |
| Sulfur | 2 | 2 | 2 | 2 | 2 | 2 | 2 | 2 |
| Vulcanization accelerator 1 | 1.5 | 1.5 | 1.5 | 1.5 | 1.5 | 1.5 | 1.5 | 1.5 |
| Vulcanization accelerator 2 | 1.5 | 1.5 | 1.5 | 1.5 | 1.5 | 1.5 | 1.5 | 1.5 |
| Vulcanization accelerator 3 | 1 | 1 | 1 | 1 | 1 | 1 | 1 | 1 |
| Content of crosslinked rubber particles per | — | — | — | 11 | 25 | 11 | 11 | 11 |
| 100 parts by mass of hydrogenated SBR | | | | | | | | |
| (parts by mass) | | | | | | | | |
| Processability | X | ◯ | X | ◯ | ◯ | ◯ | ◯ | ◯ |
| Reinforcing property | 100 | 74 | 82 | 101 | 95 | 96 | 105 | 99 |

The results are shown in Table 1. It is understood from the comparison between Comparative Example 1 and Comparative Example 2 that when a part of the hydrogenated SBR is substituted with BR, processability is improved, but reinforcing property is deteriorated. Furthermore, it is recognized from the comparison between Comparative Example 1 and Comparative Example 3 that when the amount of the oil generally used for the improvement of processability is increased, reinforcing property is deteriorated.

It is recognized from the comparison between Comparative Example 1 and Examples 1 to 5 that when the crosslinked rubber particles are used, processability is improved while maintaining or improving reinforcing property that is a property of the hydrogenated copolymer.

### INDUSTRIAL APPLICABILITY

The rubber composition for a tire of the present invention can be used in various tires of passenger cars, light trucks, buses and the like.

1. A rubber composition for a tire comprising:
100 parts by mass of a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and
3 to 30 parts by mass of crosslinked rubber particles.

2. A pneumatic tire manufactured using the rubber composition for a tire according to claim 1.
